(19) United States
(12) Patent Application Publication
(10) Pub. No.: US 2014/0165809 A1
(43) Pub. Date: Jun. 19, 2014

(54) EDGE BAND CUTTING DEVICE

(71) Applicant: Chin-Chi Lin, Taichung City (TW)

(72) Inventor: Chin-Chi Lin, Taichung City (TW)

(21) Appl. No.: 13/717,157

(22) Filed: Dec. 17, 2012

(51) Int. Cl. B26D 7/26

(52) U.S. Cl. CPC B26D 7/2628
USPC 83/522.11; 83/699.51

(57) ABSTRACT

An edge band cutting device includes a fixed unit, a movable plate movable on a base plate of the fixed unit, a cutter unit including a main cutter and an auxiliary cutter, an adjustable positioning unit abutting removably against the main cutter, and an adjustable supporting unit disposed on the fixed unit. The base plate has an opening. A space between the main cutter and the auxiliary cutter is aligned with the opening. The adjustable supporting unit includes an adjustable supporting member disposed movably on a pressing plate of the fixed unit, and a locking member for locking the adjustable supporting member on the pressing plate to allow the adjustable supporting member to be retracted into or extended from the pressing plate.

### BACKGROUND OF THE INVENTION

1. Field of the Invention

This invention relates to a cutting device, and more particularly to an edge band cutting device.

2. Description of the Related Art

DE202011108007.6 discloses an edge band cutting device, which includes a fixed unit, a moving unit, a cutter unit, and an adjusting unit, and which, through operation of an adjusting member, the length of a segment of the edge band between a cut end and an adhered terminal end can be controlled to be equal to the distance between the start end and the adhered terminal end so that, when the segment is adhered to the plank, the cut end can be brought into intimate contact with the start end without further cutting operation performed on the segment, thereby reducing the machining costs.

The supportability of the edge band cutting device needs to be improved, and a more convenient adjustment is required.

Furthermore, the aforesaid edge band cutting device further includes a positioning unit that is disposed on a pressing plate. The positioning unit has numerous components, and is troublesome to manufacture and assemble.

### SUMMARY OF THE INVENTION

The object of this invention is to provide an edge band cutting device that can adjust the cut length of an edge band, that can improve the supportability, and that has a simple structure.

According to this invention, an edge band cutting device includes a fixed unit, a movable plate movable on a base plate of the fixed unit, a cutter unit including a main cutter and an auxiliary cutter, an adjustable positioning unit abutting removably against the main cutter, and an adjustable supporting unit disposed on the fixed unit. The base plate has an opening. A space between the main cutter and the auxiliary cutter is aligned with the opening. The adjustable supporting unit includes an adjustable supporting member disposed movably on a pressing plate of the fixed unit, and a locking member for locking the adjustable supporting member on the pressing plate to allow a supporting portion of the adjustable supporting member to be retracted into or extended from the pressing plate.

By moving the adjustable positioning member to align with the start end of the edge band, the cut length of the edge band can be adjusted to eliminate further operation performed on the cut end of the edge band. By adjusting the adjustable supporting member, the cut length of the edge band also can be adjusted, and the supportability is improved.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a top perspective view of the preferred embodiment of an edge band cutting device according to this invention;

FIG. 2 is a bottom perspective view of the preferred embodiment;

FIG. 3 is a top view of the preferred embodiment;

FIG. 4 is a front view of the preferred embodiment;

FIG. 5 is an enlarged view of a portion of FIG. 3, illustrating an adjustable supporting unit;

FIG. 6 is a schematic top view of the preferred embodiment, illustrating that an edge band is adhered to a curved peripheral surface of a plank;

FIG. 7 is a view similar to FIG. 6 but illustrating how the cut length of the edge band is controlled;

FIG. 8 is a schematic top view of the preferred embodiment, illustrating that an edge band is adhered to a straight peripheral surface of a plank;

FIG. 9 is a sectional view taken along line IX-IX in FIG. 8; and

FIG. 10 is a top view of the preferred embodiment, when cutting an edge band at a corner of a plank.

### DETAILED DESCRIPTION OF THE PREFERRED EMBODIMENT

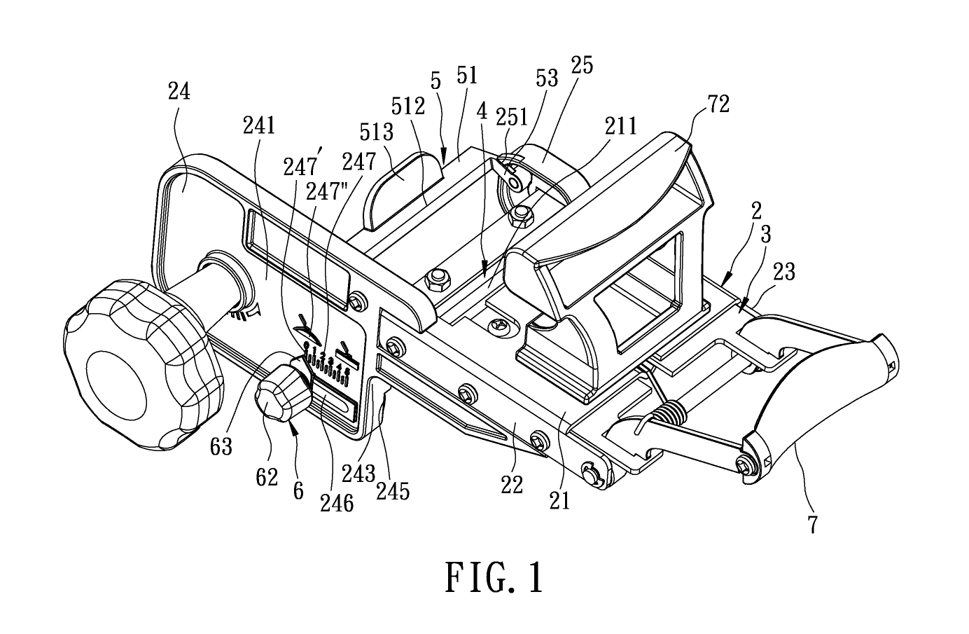

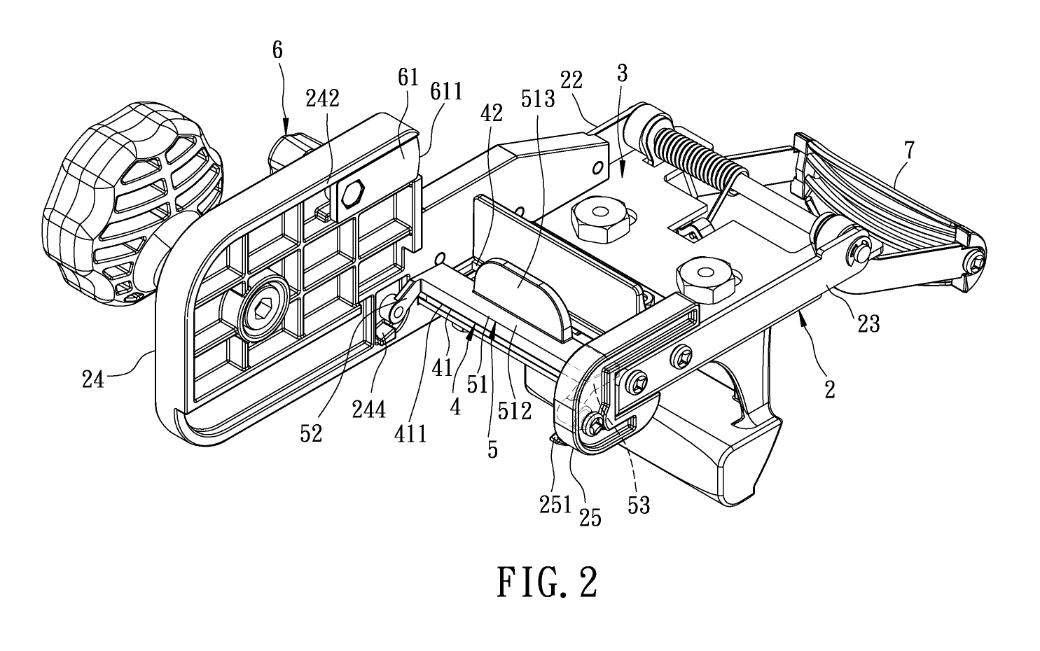

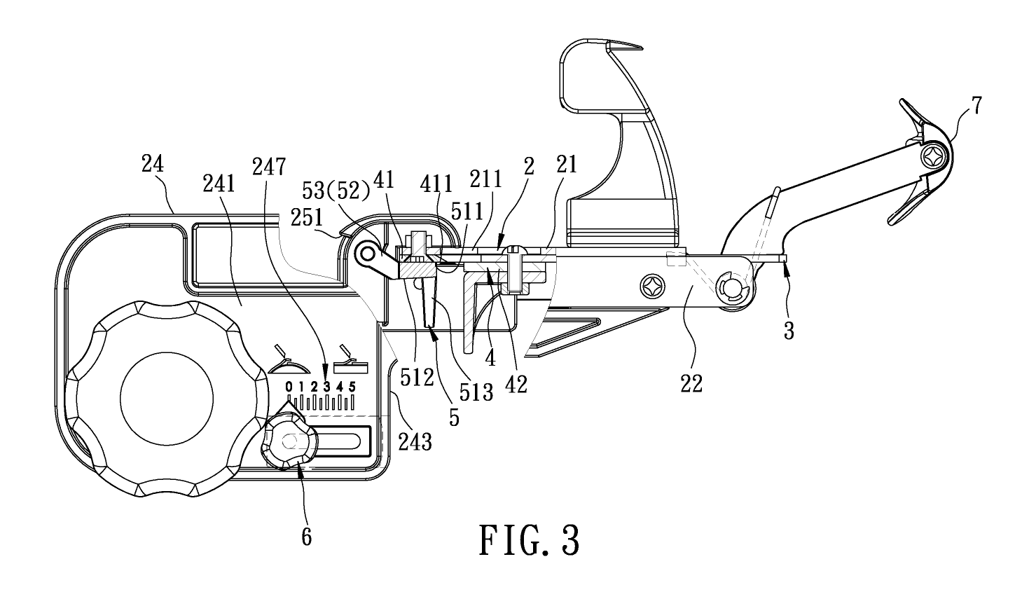

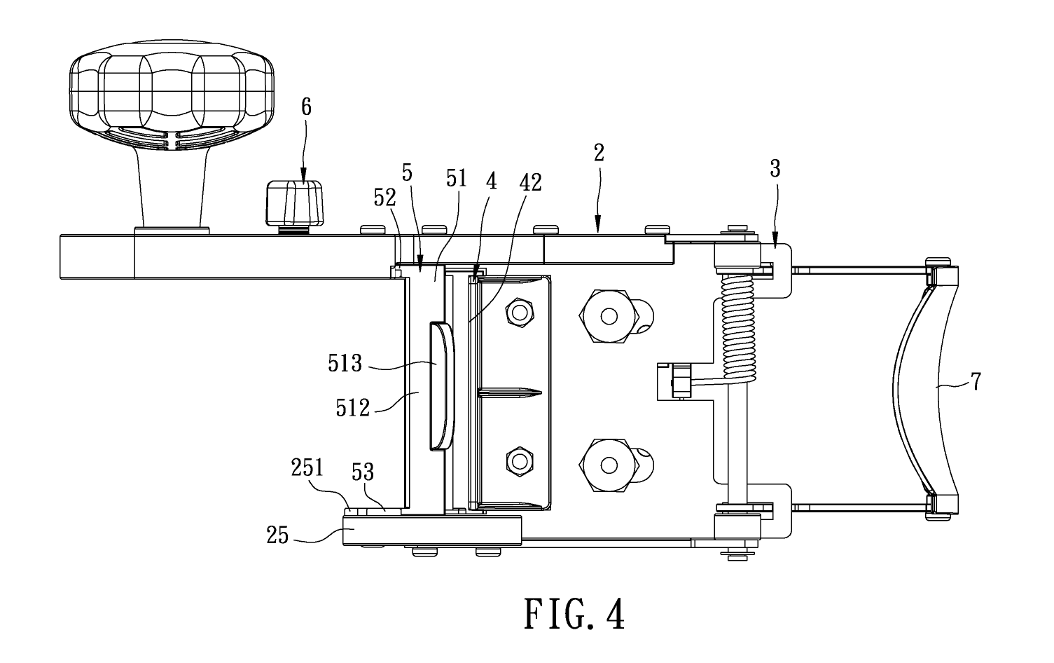

Referring to FIGS. 1, 2, 3, and 4, the preferred embodiment of an edge band cutting device according to this invention includes a fixed unit 2, a movable plate 3, a cutter unit 4, an adjustable positioning unit 5, an adjustable supporting unit 6, and a handle unit 7. In FIG. 1, the adjustable positioning unit 5 is removed from the cutter unit 4. In FIGS. 2, 3, and 4, the adjustable positioning unit 5 abuts against the cutter unit 4.

The fixed unit 2 includes a base plate 21 having an opening 211, a top plate 22 connected to the base plate 21, a main bottom plate 23 connected to the base plate 21 and disposed under the top plate 22, a pressing plate 24 connected to the top plate 22 and perpendicular to the base plate 21, and an auxiliary bottom plate 25 connected to the main bottom plate 23. The pressing plate 24 and the auxiliary bottom plate 25 have aligned limiting portions 244, 251, respectively.

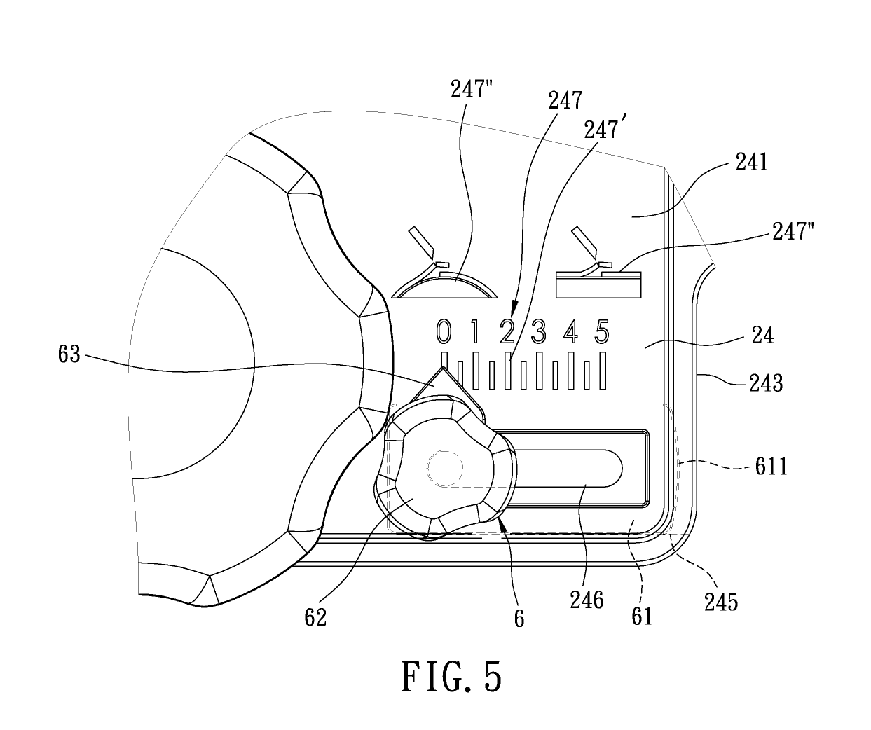

With further reference to FIG. 5, the pressing plate 24 further includes a top surface 241, a bottom surface 242 opposite to the top surface 241, a side edge 243 connected between the top surface 241 and the bottom surface 242, a guide slot 245 formed in the bottom surface 242 and extending through the side edge 243, along slot 246 formed in the top surface 241 and in spatial communication with the guide slot 245, and an indication portion 247 adjacent to a side of the long slot 246. The indication portion 247 has a scale 247′ disposed along a longitudinal direction of the long slot 246, and two illustrative patterns 247″ adjacent to a side of the scale 247′. The illustrative patterns 247″ show the profiles of the plank to be machined.

The movable plate 3 is movable on the base plate 21, and is disposed between the top plate 22 and the bottom plate 23.

The cutter unit 4 includes a main cutter 41 disposed on the base plate 21 and having a back surface 411 facing away from the base plate 21, and an auxiliary cutter 42 disposed on the movable plate 3. A space between the main and auxiliary cutters 41, 42 is aligned with the opening 211.

The adjustable positioning unit 5 includes an adjustable positioning member 51 abutting removably against the back surface 411 of the main cutter 41, and two swing arms 52, 53 connected to the adjustable positioning member 51, connected respectively and pivotally to the pressing plate 24 and the auxiliary bottom plate 25, and pivotable to abut against the limiting portions 244, 251, respectively.

The adjustable positioning member 51 has a positioning portion 511, an abutting surface 512, and an operating plate 513. The abutting surface 512 is opposite to the back surface 411 of the main cutter 41. The positioning portion 511 is opposite to the abutting surface 512. The operating plate 513 is connected to the abutting surface 512.

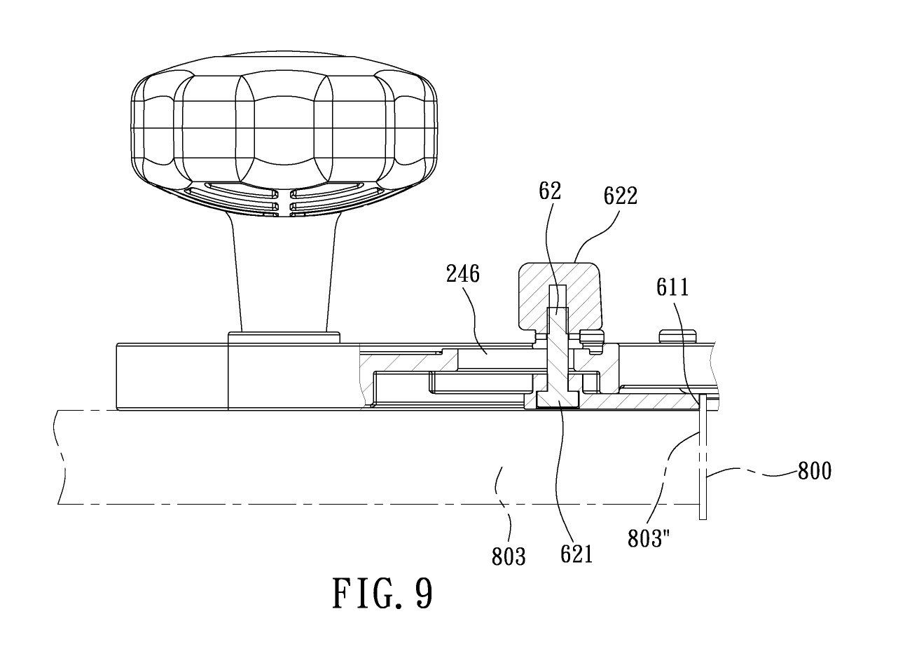

With particular reference to FIG. 5, the adjustable supporting unit 6 includes an adjustable supporting member 61 disposed movably on the pressing plate 24, a locking member 62 operable for locking the adjustable supporting member 61 on the pressing plate 24, and an pointer 63 connected to the adjustable supporting member 61 and the locking member 62. The adjustable supporting member 61 is configured as a plate, is disposed movably in the guide slot 245, and has a supporting portion 611 retractable into or extendable from the side edge 243. The locking member 62 includes a threaded rod 621 (see FIG. 9) connected to the adjustable supporting member 61 and extending through the long slot 246, and a knob 622(see FIG. 9) connected to the threaded rod 621 for manual operation. The pointer 63 is disposed on the top surface 241, and is aligned with the indication portion 247.

The handle 7 is disposed pivotally on the fixed unit 2, and is operable to drive movement of the movable plate 3.

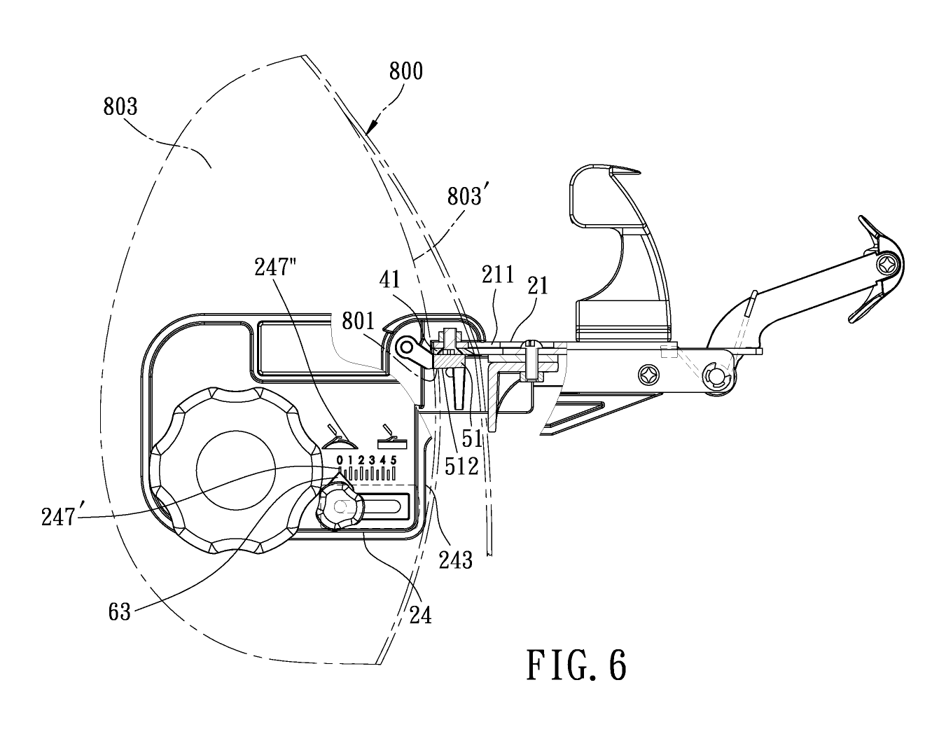

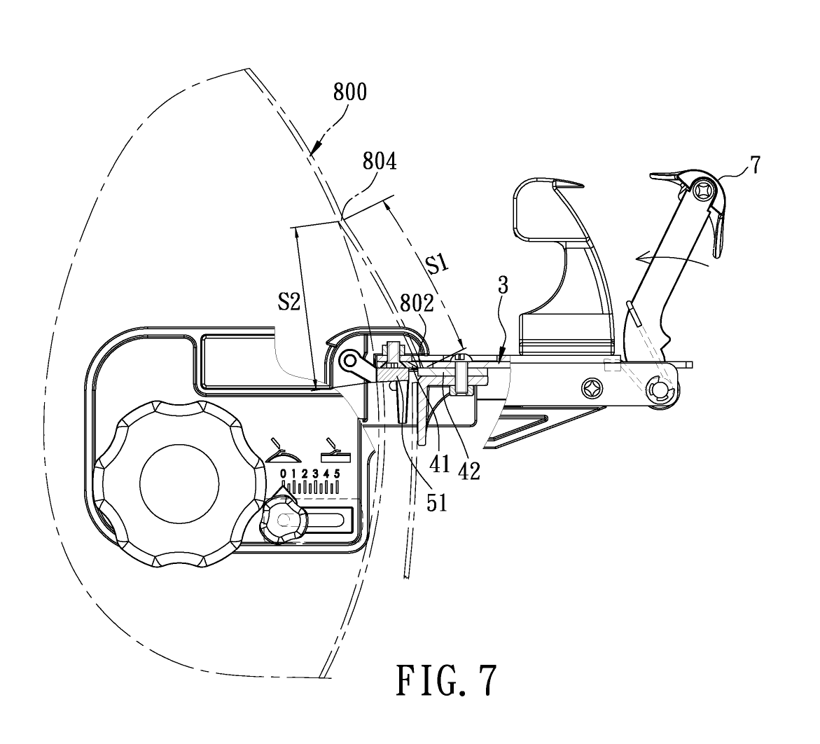

With particular reference to FIGS. 2 and 6, when it is desired to adhere an edge band 800 to a curved outer peripheral surface 803′ of a plank 803 (such as a table top) from a start end 801, the pointer 63 is moved to a position aligned with the “0” portion of the scale 247′ and, thus, one of the illustrative patterns 247″ indicative of a curved peripheral surface. At this time, the supporting portion 611 of the adjustable supporting member 61 is disposed in the side edge 243, and the adjustable positioning unit 5 is disposed at a first position shown in FIGS. 2 and 6 whereat the positioning portion 511 abuts against the back surface 411 of the main cutter 41. Subsequently, the edge band 800 is extended and adhered over the full length of the outer periphery of the plank 803, and a non-adhered trailing end portion of the edge band 800 is passed through the opening 211 in the base plate 21. The pressing plate 24 is placed on the plank 803 so that the side edge 243 abuts against an upper end of an inner side surface of a portion of the end edge 800 adhered to the plank 803. Afterwards, the abutting surface 512 of the adjustable positioning member 51 is moved to contact the start end 801, as shown in FIG. 6. At this time, the handle 7 is operated to move the movable plate 3 and the auxiliary cutter 42 toward the main cutter 41 for cutting the edge band 800, as shown in FIG. 7.

In this manner, with further reference to FIG. 7, the length (S1) of a segment of the edge band 800 between a cut end 802 and an adhered terminal end 804 can be controlled to be equal to the distance (S2) between the start end 801 and the adhered terminal end 804 so that, when the segment is adhered to the plank 800, the cut end 802 can be brought into intimate contact with the start end 801 without further cutting operation performed on the segment, thereby reducing the manufacturing costs.

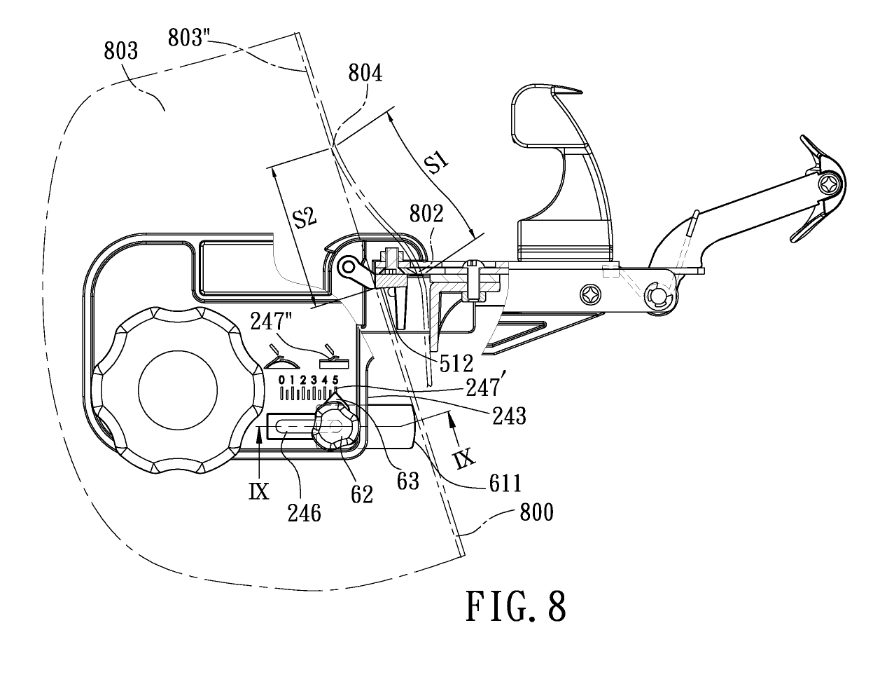

With further reference to FIGS. 8 and 9, when it is desired to adhere an edge band 800 to a straight peripheral surface 803″ of a plank 803, the locking member 62 is moved along the long slot 246 to allow the supporting portion 611 to extend from the side edge 243, and the pointer 63 is moved to a position aligned with the “5” portion of the scale 247′ and, thus, one of the illustrative patterns 247″ indicative of a straight peripheral surface. Subsequently, the abutting surface 512 is brought into contact with the start end 801, and the supporting portion 611 is moved into contact with an upper end of an inner side surface of a portion of the edge band 800 adhered to the plank 803. In this manner, when the edge band 800 is cut, the length (S1) of a segment of the edge band 800 between a cut end 802 and an adhered terminal end 804 is equal to the distance (S2) between the start end 801 and the adhered terminal end 804. Such an operation has an advantage. That is, the supporting portion 611 abuts against an upper end of the edge band 800, so as to form a supporting point for supporting the edge band cutting device on the plank 803, thereby resulting in a stable operation.

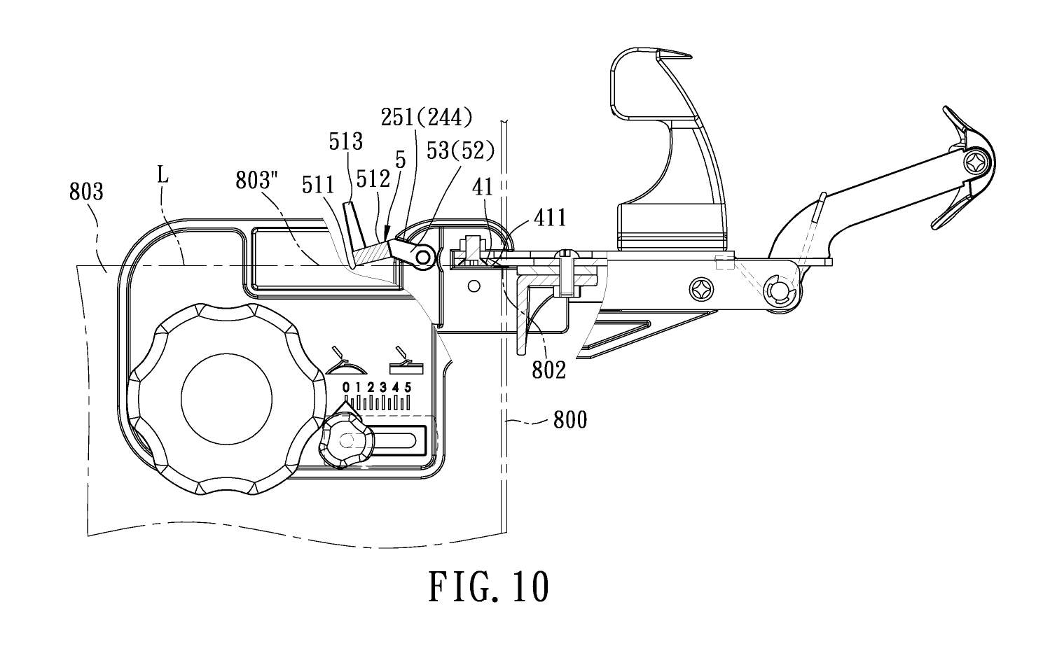

With particular reference to FIGS. 1, 2, and 10, when the edge band 800 is cut at a corner of a plank 803, it is only necessary to operate the operating plate 513 to pivot the adjustable positioning unit 5 from the first position to a second position whereat the adjustable positioning member 51 is removed from the main cutter 41, whereat the swing arms 52, 53 abut respectively against the limiting portions 244, 251, and whereat the adjustable positioning member 51 is located on the extension line (L) of the back surface 411 of the main cutter 41 . At this time, the positioning portion 511 of the adjustable positioning member 51 is brought into contact with a straight peripheral surface 803″ disposed at a side of the corner, so as to facilitate the back surface 411 of the main cutter 41 to contact stably the straight peripheral surface 803″, thereby maintaining the cut end 802 at a vertical position.

As such, by pivoting the adjustable positioning member 51 from the first position to the second position, the adjustable positioning member 51 can be used for adjustment and positioning during the corner cutting operation.

With this invention thus explained, it is apparent that numerous modifications and variations can be made without departing from the scope and spirit of this invention. It is therefore intended that this invention be limited only as indicated by the appended claims.

I claim:

1. An edge band cutting device comprising:
a fixed unit including abase plate having an opening, and a pressing plate connected to and perpendicular to said base plate;
a movable plate movable on said base plate;
a cutter unit including a main cutter disposed on said base plate, and an auxiliary cutter disposed on said movable plate, a space between said main and auxiliary cutters being aligned with said opening, said main cutter having a back surface opposite to the base plate;
an adjustable positioning unit including an adjustable positioning member abutting removably against said back surface of said main cutter, said adjustable positioning member having an abutting surface opposite to said main cutter; and
an adjustable supporting unit including an adjustable supporting member disposed movably on said pressing plate, and a locking member operable to lock said adjustable supporting member on said pressing plate, said adjustable supporting member having a supporting portion retractable into or extendable from said pressing plate.

2. The edge band cutting device as claimed in claim 1, wherein said pressing plate has a top surface, a bottom surface opposite to said top surface, a side edge connected between said top surface and said bottom surface, a guide slot formed in said bottom surface and extending through said side edge, and a long slot formed in said top surface and in spatial communication with said guide slot, said adjustable supporting member being disposed movably in said guide slot, said locking member including a threaded rod connected to said adjustable supporting member and extending through said long slot, and a knob connected to said threaded rod for manual operation.

3. The edge band cutting device as claimed in claim 2, wherein said pressing plate further has an indication portion disposed on said top surface and adjacent to a side of said long slot, said adjustable supporting unit further including an pointer connected to said adjustable supporting member and said locking member, said pointer being disposed on said top surface and being aligned with said indication portion.

4. The edge band cutting device as claimed in claim 3, wherein said indication portion of said fixed unit has a scale disposed along a longitudinal direction of said long slot, and a plurality of illustrative patterns adjacent to a side of said scale.

5. The edge band cutting device as claimed in claim 1, said fixed unit further includes a top plate and a main bottom plate that are connected to said base plate, as well as an auxiliary bottom plate connected to said main bottom plate, said pressing plate being connected to said top plate.

6. The edge band cutting device as claimed in claim 5, wherein said auxiliary bottom plate and said pressing plate of said fixed unit have aligned limiting portions, respectively, said adjustable positioning unit further including two swing arms connected to said adjustable positioning member and connected respectively and pivotally to said pressing plate and said auxiliary bottom plate, said adjustable positioning member further having a positioning portion opposite to the abutting surface, said adjustable positioning unit being pivotable between a first position whereat said positioning portion abuts against said back surface of said main cutter, and a second position whereat said adjustable positioning member is removed from said main cutter, whereat said swing arms abut respectively against said limiting portions, and whereat said positioning portion of said adjustable positioning member is located on an extension line of said back surface of said main cutter.

7. The edge band cutting device as claimed in claim 6, wherein said adjustable positioning member of said adjustable positioning unit further has an operating plate connected to the abutting surface for manual operation.
